(19) United States
(12) Patent Application Publication
(10) Pub. No.: US 2003/0167598 A1
(43) Pub. Date: Sep. 11, 2003

(54) Hinge for a hinged cover, especially the trunk cover of an automobile

(76) Inventors: Ulrich Koestler, Hebertshausen (DE); Michael Rothe, Olching (DE); Marcus Knechtel, Muenchen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/324,106

(22) Filed: Dec. 20, 2002

(30) Foreign Application Priority Data
Dec. 21, 2001 (DE) 101 63 299.1

(51) Int. Cl. E05F 1/08

(52) U.S. Cl. 16/289

(57) ABSTRACT

The trunk cover of an automobile is mounted via two four-joint hinges, positioned a certain distance from one another, such that it can pivot. Each of the four-joint hinges has a receptacle component, fixed to the vehicle body, to which first and second pivoted levers are mounted such that they can pivot. A bearing component, to which the trunk cover is fastened, is linked to the opposite end sections of the hinges. Further, a receptacle pin, which supports a leg spring, is fastened to the receptacle component. This spring includes a first spring leg attached to the receptacle pin such that it cannot rotate and a second, prestressed spring leg which lies adjacent to a tensioning pin of the second pivoting lever. Immediately after the trunk cover has been opened, an open end of the cover, which faces the vehicle body, is shifted upward.

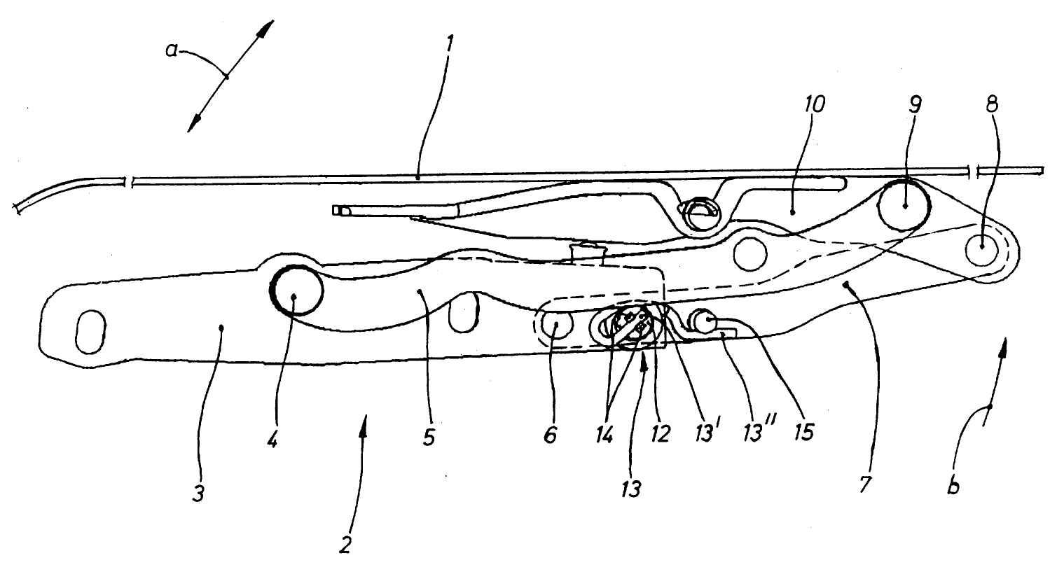

This application claims the priority of German application 101 63 299.1, filed Dec. 21, 2001, the disclosure of which is expressly incorporated by reference herein.

### BACKGROUND AND SUMMARY OF THE INVENTION

The present invention relates to a hinge for a hinged trunk cover of an automobile including a receptacle component mounted firmly to a vehicle body, first and second pivoted levers linked to the vehicle body and spaced a certain distance from one another, a bearing component to which the levers are fastened such that they can pivot at their opposite end sections, the bearing component being mounted to the hinged cover, and at least one prestressed spring element which, in an opening phase of the hinged cover, acts upon one of the first and second pivoted levers. Such a hinge is disclosed in German publication DE 197 21 941 A1.

In the luggage trunk cover known from the German publication mentioned, each of the hinges has four-joint kinematics and is equipped with a receptacle component mounted on the vehicle body and a bearing component mounted on the cover. The two components have a hinged connection with one another, and include a first, long pivoted lever and a second, short pivoted lever. Because only a relatively small amount of force is needed to initiate the opening phase of the trunk cover, a leaf spring is provided, along with a gas pressure cylinder, wherein the leaf spring is mounted on the receptacle component, with its free end adjacent to the underside of the end section of the first pivoted lever, which is on the side of the bearing component. Because the point of contact for the leaf spring is set back from the link on its bearing side about one-third of the length of the first pivoted lever, and because the leaf spring is set inward at a greater distance from the bearing-side link of the second pivoted lever, the free end sections of the edges of the trunk cover, which face the body of the vehicle, are displaced downward during the opening phase of the trunk cover. This effect is intensified by the force from the gas pressure cylinder and the effect of the prestressed rubber gasket on the trunk cover, which is released during opening. For reasons of style, very small seams are often provided between the open ends of the edges of the trunk cover and the vehicle body. As a result, the trunk cover can come into contact with portions of the vehicle body, causing damage to it.

It is thus one object of this invention to position a spring element within a hinge of the type specified above such that an open, hinge-side end of the hinged cover cannot come into contact with a component fixed on the vehicle body and facing the hinged cover.

To accomplish the task, the second pivoted lever is acted upon by the spring element, thus preventing a downward movement of a hinge-side, open end of the hinged cover.

Because the spring element acts with an initial tension upon the second, short pivoted lever in the opening direction of the hinged cover, the cover is also shifted upward at its hinge-side open end; starting with the opening movement, it prevents the edges of the hinged cover, which extend toward the vehicle body, from coming into contact with the body. This is achieved in a very simple and cost-effective manner, without increasing the weight of the arrangement.

The spring element expediently includes a leg spring, which is fastened to the first spring leg of the receptacle component such that it cannot rotate, while its second, prestressed spring leg lies adjacent to a tensioning pin of the second pivoted lever. The leg spring is thus mounted in a very simple manner to the receptacle component, and can be replaced if necessary. Furthermore, the leg springs described can also be retrofitted.

One example is illustrated in the drawing and will be described in detail below.

### BRIEF DESCRIPTION OF THE DRAWING

The drawing shows a four-joint hinge mounted in the area of the trunk of an automobile, wherein the trunk cover is in a closed position.

### DETAILED DESCRIPTION OF THE INVENTION

A trunk cover 1 of an automobile, shown in a partial illustration in the drawing, is mounted such that it can pivot in the directions indicated by the double arrow a, using two four-joint hinges 2, spaced a certain distance from one another in the area of the trunk. The four-joint hinge 2 is further equipped with a receptacle component 3 fixed firmly to the vehicle body, to which a first, long pivoted lever 5 is linked via a bearing pin 4. A second, short pivoted lever 7 is fastened to the receptacle component 3 via a bearing pin 6 such that it can pivot and is spaced a certain distance from the bearing pin 4. A bearing component 10 is linked to the end section of the short pivoted lever, and to the end section of the first pivoted lever 5, via the bearing pins 8 and 9. The trunk cover 1 is fastened to this bearing component.

As is apparent in the drawing, a receptacle pin 12 is arranged on the receptacle component 3, adjacent to the bearing pin 6 of the second pivoted lever 7, with the receptacle pin being encompassed by a leg spring 13. The first spring leg 13′ of the leg spring, formed by an end section, is positioned, such that it cannot rotate, between two retention pins 14 that lie at a certain distance from one another and a certain distance from the end surface of the receptacle pin 12. In contrast, the second, prestressed spring leg 13″ of the leg spring 13 lies adjacent to a flat area of a tensioning pin 15, positioned a distance from the second pivoted lever 7. Due to the action of the prestressed leg spring 13 upon the second pivoted lever 7, immediately after the trunk cover 1 has been unlocked and placed in the subsequent opening phase, the cover is shifted in the direction of the arrow b, in other words upward, thus preventing the downward movement of the open end of the trunk cover 1 that lies in the area of the four-joint hinge 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A hinge for a hinged cover of an automobile, comprising:
a receptacle component mounted firmly to a vehicle body,
first and second pivoted levers linked to the vehicle body and spaced a certain distance from one another,
a bearing component to which the levers are fastened such that they can pivot at their opposite end sections, the bearing component being mounted to the hinged cover, and
at least one prestressed spring element which, in an opening phase of the hinged cover, acts upon one of the first and second pivoted levers,
wherein the second pivoted lever is acted upon by the spring element, thus preventing a downward movement of a hinge-side, open end of the hinged cover.

2. The hinge in accordance with claim 1, and further comprising a receptacle pin mounted on the receptacle component for the spring element, wherein a first spring leg of the spring element is mounted to the receptacle pin such that it cannot rotate, and wherein a second, prestressed spring leg lies adjacent to a tensioning pin of the second pivoted lever.

3. The hinge in accordance with claim 1, wherein the hinged cover is a trunk cover.

4. The hinge in accordance with claim 1, wherein the spring element is a leg spring.

5. A process of moving a hinged cover of an automobile while avoiding contact between the hinged cover and a vehicle body, comprising:
providing a hinge having a receptacle component mounted firmly to a vehicle body, first and second pivoted levers linked to the vehicle body and spaced a certain distance from one another, and a bearing component to which the levers are fastened such that they can pivot at their opposite end sections, the bearing component being mounted to the hinged cover,
moving the hinged cover in an opening phase, and
preventing a downward movement of a hinge-side, open end of the hinged cover with at least one prestressed spring element which, in the opening phase of the hinged cover, acts upon the second pivoted lever.

6. The process in accordance with claim 5, wherein a receptacle pin is mounted on the receptacle component for the spring element, wherein a first spring leg of the spring element is mounted to the receptacle pin such that it cannot rotate, and wherein a second, prestressed spring leg lies adjacent to a tensioning pin of the second pivoted lever.

7. The process in accordance with claim 5, wherein the hinged cover is a trunk cover.

8. The process in accordance with claim 5, wherein the spring element is a leg spring.
